(19) United States
(12) Patent Application Publication
(10) Pub. No.: US 2005/0289179 A1
(43) Pub. Date: Dec. 29, 2005

(54) Method and system for generating concept-specific data representation for multi-concept detection

(76) Inventors: Milind R. Naphade, Fishkill, NY (US); Apostol Ivanov Natsev, White Plains, NY (US); John R. Smith, New York, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/874,553

(22) Filed: Jun. 23, 2004

(51) Int. Cl. G06F 7/00

(52) U.S. Cl. 707/104.1

(57) ABSTRACT

A system and method for detecting a concept from digital content are provided. A plurality of representations is generated for same data content for concept detection from the plurality of representations. A plurality of concepts is simultaneously detected from the plurality of representations of the same data content wherein at least one detector provides selection information for selecting the representations generated or a combination of the generated representations. This results in multiple instances of a representation being considered for concept detection.

### BACKGROUND

1. Technical Field

The present disclosure relates a method and system for generating concept-specific data representations for multi-concept detection, and more particularly, to a system and method which employs more than one data representation in concept detection.

2. Description of the Related Art

Data management requires the generation of meta-data for facilitating efficient indexing, filtering and searching capabilities. It is often necessary to develop tools that allow users to associate concepts with data. However, the abundance of data and diversity of concepts makes this a difficult and overly expensive task. In particular, the task of detecting the concept using the appropriate set of one or more data representations is extremely important.

Given that data management and data management systems are essential in virtually every industry, concept detection is becoming more important in data management applications. Learning and classification techniques are increasingly relevant to state-of-the art data management systems. From relevance feedback to statistical semantic modeling, there has been a shift in the amount of manual supervision needed, from lightweight classifiers to heavyweight classifiers.

It is therefore a consequence that machine learning and classification techniques make an increasing impression on the state of the art in data management. Techniques that use data representations for concept detection include, for example, Naphade et al. (Naphade et al., “A Framework for Moderate Vocabulary Semantic Visual Concept Detection”, IEEE International Conference on Multimedia and Expo 2003). Similar techniques exist for detection of concepts from text, media, etc.

One important issue includes the type of representation used for detection of information in data. In some cases, the representation may include all the data (an image, a video, a text document, etc.) or part of the data (a region in an image, a paragraph in a document, etc.). In many cases, a fixed set of multiple representations is used. Prominent among these are the multi-scale techniques that use wavelet-based processing for detection as in Koller et al. (T. Koller et al., “Multiscale detection of curvilinear structures in 2-D and 3-D image data”, 5th International Conference on Computer Vision, June 1995.

Multi-scale techniques are one instance of how multiple representations can be developed. However, in conventional techniques, the procedure that creates the representation is not determined based on a set of concepts, which are to be detected in the representation. Instead, the content is merely searched for in a given concept without adapting to the type of concept being searched.

### SUMMARY

A system and method for detecting a concept from digital content are provided. A plurality of representations is generated for same data content for concept detection from the plurality of representations. A plurality of concepts is simultaneously detected from the plurality of representations of the same data content wherein at least one detector provides selection information for selecting the representations generated or a combination of the generated representations. This results in multiple instances of a representation being considered for concept detection.

A method for detecting a concept from digital content, includes providing digital content, representing the digital content in a plurality of representations, generating a set of regions for each of the plurality of representations for the same data content, simultaneously detecting a plurality of concepts from the regions, scoring each region based on confidence that the concepts exist in each region and processing region scores.

A system for detecting a concept from digital content includes a representation generation module, which represents digital content in a plurality of representations by generating a set of regions for each of the plurality of representations for the same data content. At least one concept detector simultaneously detects a plurality of concepts from the regions by comparing data in the region to concept models and scoring each region based on confidence that the concept exists in that region.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a chart showing content types and granularity hierarchy for the content types, which may be employed in accordance with the present disclosure;

FIG. 2 is a grid-based set of regions for a given image, which may be employed in accordance with the present disclosure;

FIG. 3 is a spatial layout-based set of regions for the image of FIG. 2, which may be employed in accordance with the present disclosure;

FIG. 4 is a color segmentation-based set of regions for the image of FIG. 2, which may be employed in accordance with the present disclosure;

FIG. 5 is a block/flow diagram illustrating a system/method for automatic concept detection in accordance with an embodiment the present disclosure;

FIG. 6 is a block/flow diagram illustrating a system/method for automatic concept detection for regional concepts in accordance with an embodiment of the present disclosure;

FIG. 7 is a block/flow diagram illustrating a system/method for concept-specific data representation generation for multi-concept detection in accordance with an embodiment of the present disclosure; and

FIG. 8 is a block/flow diagram illustrating a system/method for concept-specific data representation generation for single concept detection in accordance with an embodiment of the present disclosure.

### DETAILED DESCRIPTION OF PREFERRED EMBODIMENTS

A method and system for generating concept-specific data representations for multi-concept detection are provided. The method and system generate one or more representations, and the generation process is decided jointly by all the concepts in the list. This may include combining one or more representations, which are segmented using different techniques to make the combined representation suitable for improved concept detection. One aspect of the present disclosure is to avoid using the same fixed data representation for all concept detection purposes.

Instead, the present embodiments consider one or more alternative data representations and generate one final concept-specific data representation for detection purposes, where the final representation generation process is determined based upon a given set of concepts that need to be detected.

The present illustrative embodiments are applicable to all forms of data including multimedia data, text, rich media, hypertext, documents, etc. If the concept detection process needs a priori creation of concept models, a first procedure of representation generation for the purposes of concept model creation need not be the same as a second procedure of representation generation that is used for concept detection. Representation generation is a process or processes, which are employed to generate a collection of data, such as an image, an audio composition, etc. A concept model is a model used for comparison to identify a concept in given data.

The present illustrative embodiments do not require knowledge of the procedure for representation generation used for the creation of concept models. Instead, the present disclosure creates the final concept-specific and potentially data-redundant representation simultaneously based on all the concepts in a set.

One important concept is to avoid merely using the single given data representation for concept detection, especially where multiple concepts are listed in a set. Instead, one or more representations are generated jointly by all the concepts in the list, which need to be detected. For example, in multimedia annotation, the user is permitted to have a list of concepts such as “face”, “sky”, “car” and create concept-specific representations in terms of grids, layouts, segments of the multimedia content where the representations are created jointly based on the three concepts in the list. For example, since the concepts include a face, sky and car, the image will be segmented in a way that will permit the best chance of identifying these concepts in the image. This may include using semantic or relational information to isolate regions of the image. Illustratively, the sky is typically blue and may be found, usually at the top of the image. A car is often on a surface, such as an asphalt roadway and includes wheels. A face has determinable features, which can be relied upon to identify one in the image content.

It should be understood that the illustrative embodiments described herein are not limited to multimedia data alone and can be applied to all forms of data from which concepts need to be detected including text, rich media, hypertext, documents etc. In addition, these embodiments do not require that the procedure of representation generation that is used for concept detection be identical to the scheme of representation generation that is needed during the creation of the concept models used for detection. Advantageously, the illustrative embodiments do not need to know the procedure of representation generation used during the creation of the concept models used for detection.

It should be further understood that the elements shown in the FIGS. may be implemented in various forms of hardware, software or combinations thereof. Preferably, these elements are implemented in a combination of hardware and software on one or more appropriately programmed general-purpose digital computers having a processor and memory and input/output interfaces.

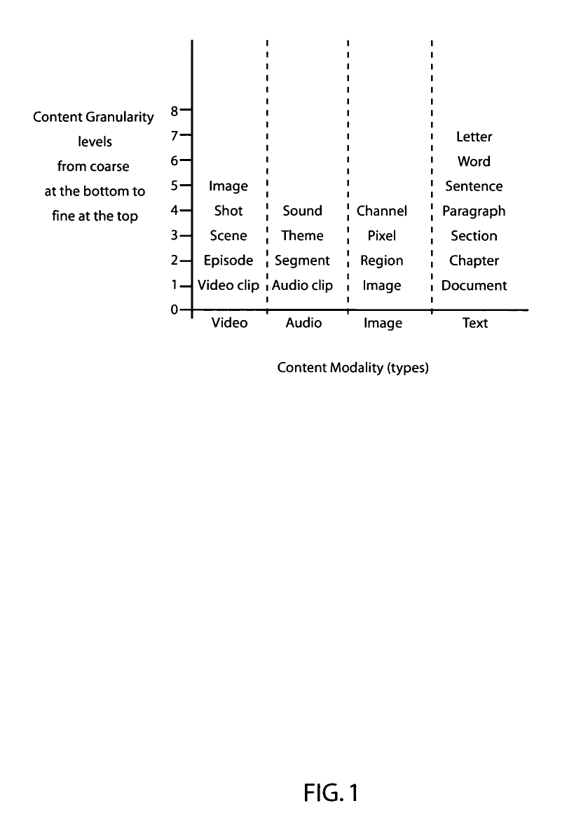

Referring now to the drawings in which like numerals represent the same or similar elements and initially to FIG. 1, a chart illustratively depicts a plurality of content modality types having different granularity levels, which are useful in accordance with the embodiments described herein. FIG. 1 illustrates various content granularity and modality examples. Content may be classified into different content modalities (a non-exhaustive list is provided in FIG. 1) and for each modality there are various content granularities, ranging from coarser granularity (0 at the bottom of FIG. 1) to finer granularity (8 or higher at the top of FIG. 1).

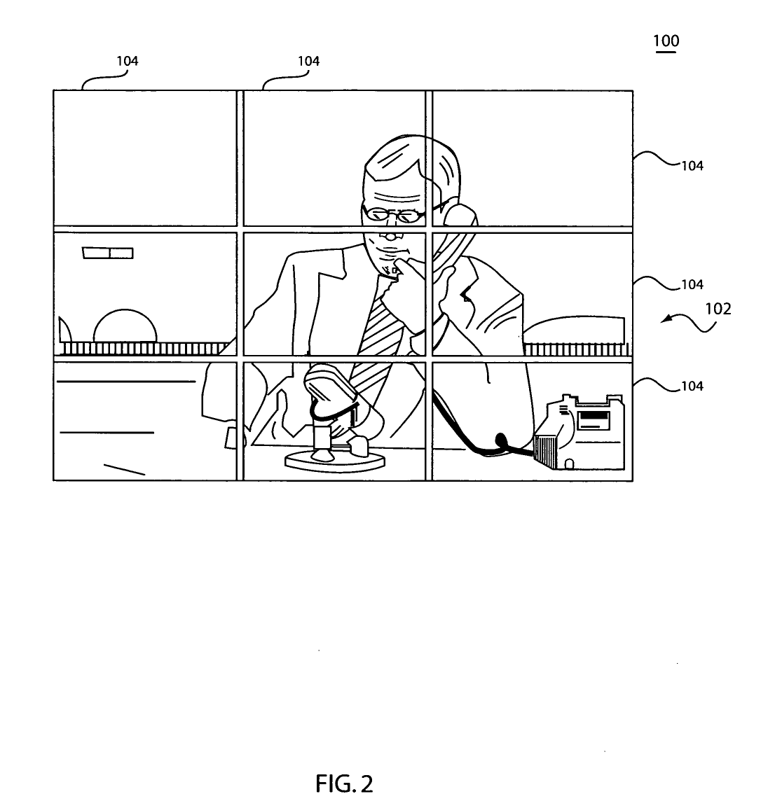

Given a piece of content at a given modality and granularity, there are multiple representations of the same content at a finer granularity. For example, an image can be represented at a finer granularity as a set of image regions, and there are multiple sets of image regions that can represent the same image, as illustratively shown in FIGS. 2-4.

Referring to FIG. 2, set-of-region representations 102 are shown where each region 104 is constructed by dividing an image 100 into, for example, a regular 3×3 grid of regions. The grid regions 104 are determined by dividing the image into 3 equal horizontal partitions and 3 equal vertical partitions, resulting in a total of 9 equally sized regions. In this example, 9 regions are employed, however, the present embodiments may be extended to any number of regions 104. For example, the same principle may be applied to general H×V regular grid-based subdivision resulting in H*V number of equally sized regions.

The grid-based representation 102 is an example of a complete representation, or one where the set of finer-granularity content pieces (e.g., the image regions 104) cover the entire content piece at the coarser granularity (e.g., the whole image 100). The grid-based representation 102 is also a non-redundant representation, or one where the set of finer-granularity content pieces (e.g., the image regions 104) are mutually exclusive (e.g., do not overlap).

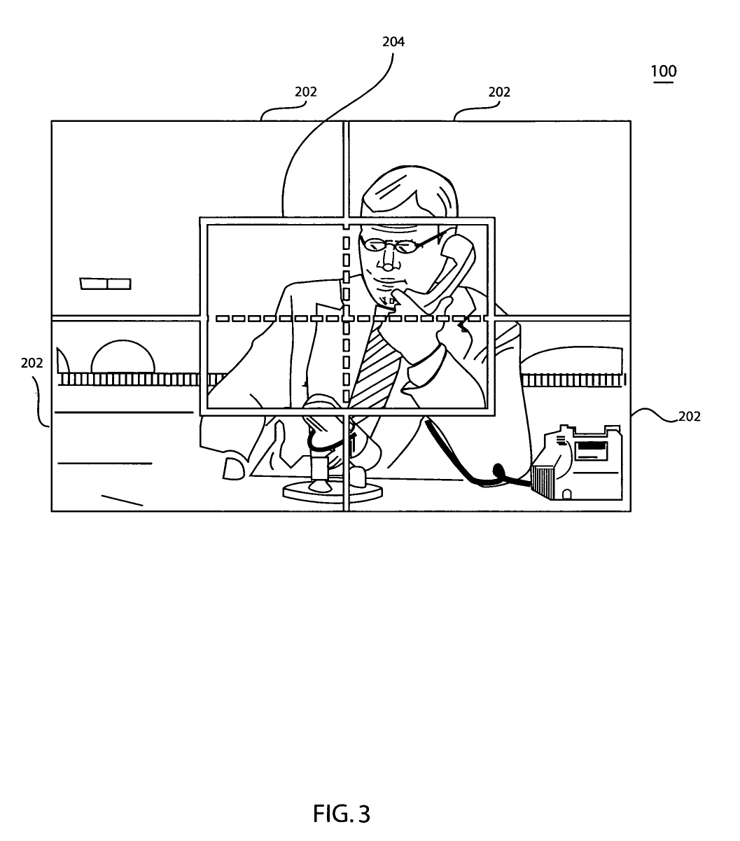

Referring to FIG. 3, an example of a redundant representation based on a spatial layout subdivision of the image 100 of FIG. 2 is shown. In a layout-based representation, the image 100 is sub-divided into 4 equally-sized corner regions 202 based on a 2×2 grid-based sub-division and an additional center region 204 of the same size as regions 202 is added for a total of 5 equally-sized regions. The layout-based representation is redundant because the center region 204 overlaps with the four corner regions 202. The layout-based representation can be generalized by overlapping an arbitrary regular grid-based representation (e.g., the 2×2 grid) with another representation based on regions of interest (e.g., the center region 204). In general, combining 2 or more representations of the same content yields another representation, which is usually (although not necessarily) redundant.

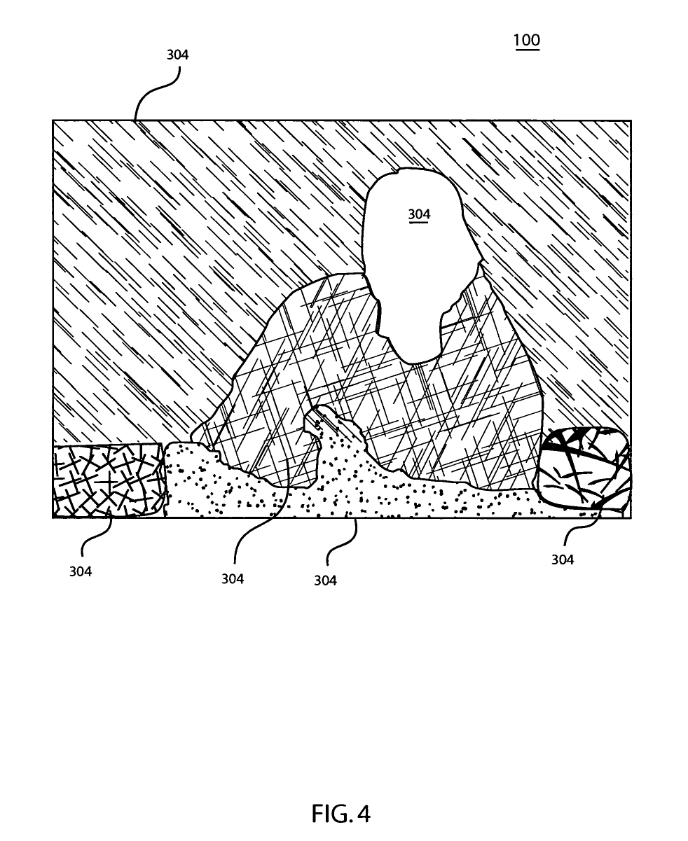

When a content representation is complete and non-redundant, it is called a segmentation of the content. One example of segmentation for the image of FIGS. 2-3 is shown in FIG. 4, where the image is segmented into homogeneous regions based on their color.

Referring to FIG. 4, color segmentation-based set-of-region representation for a given image may be employed. Regions 304 are determined by segmenting the image 100 into regions of homogeneous color, resulting in a plurality of different regions for the image. By definition, segmentation results in a complete and non-redundant representation of the content. Similar to color-segmentation, texture-based segmentation may also be employed using texture instead of colors.

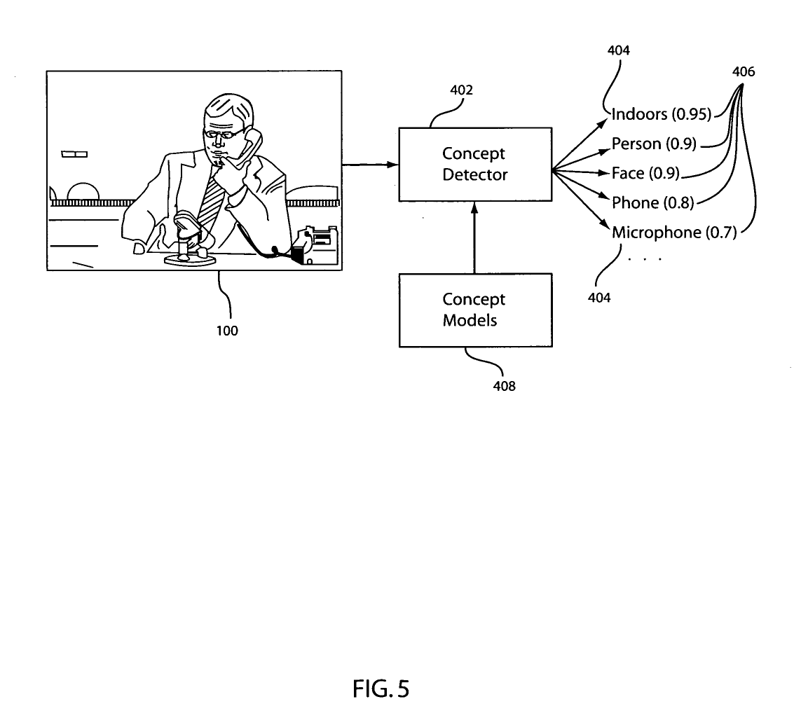

Referring to FIG. 5, concept detection includes the process of identifying and automatically labeling content. Given a content example from a given modality and granularity, the concept detection process associates one or more semantic labels with the content along with a degree of detection confidence for each label. In one embodiment, this includes a concept detector 402, which takes as input, a given content, such as an image 100 and outputs associated labels 404 and corresponding detection confidences 406 for each label 404. The concept detector 402 may optionally look up concept models 408 from a repository to evaluate whether the corresponding concepts apply to the given content or not.

The given representation of the content may not be the most appropriate representation for the detection of some concepts, however. For example, many concepts are regional by nature and by definition may occupy only a portion of the provided content. In other words, a different portion or region in an image may have different significance based upon information in other regions of the image. These relationships may be dealt with by appropriately training the system using, for example, concept models to provide this information.

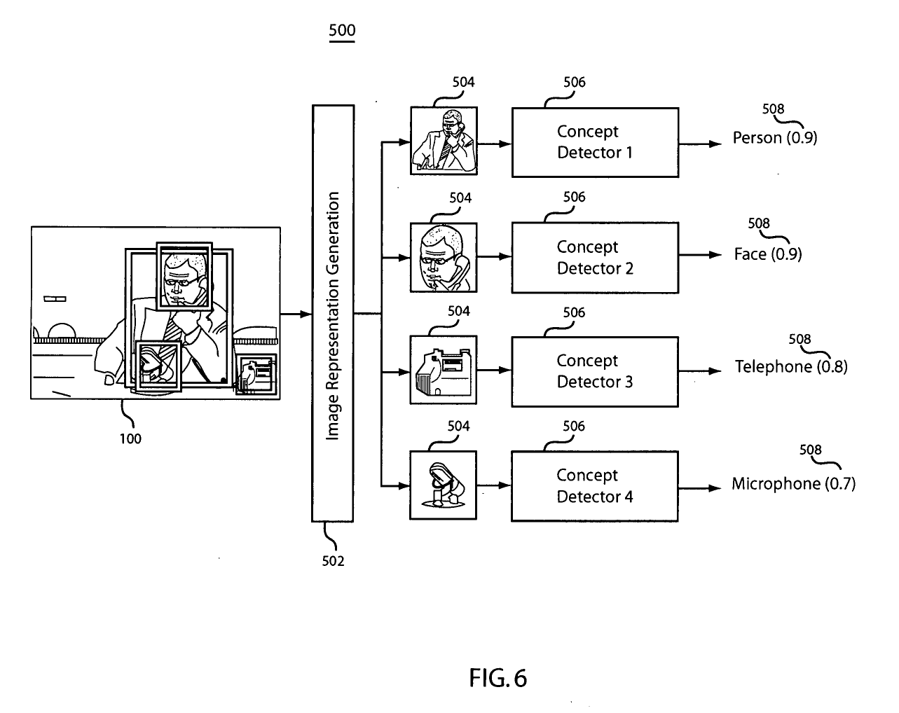

Examples of such concepts along with the associated content regions they occupy are illustratively shown in FIG. 6.

Referring to FIG. 6, an illustrative embodiment of a regional concept detection system 500 is shown. System 500 identifies where a target set of concepts (e.g., Face, Person, Microphone, Telephone) are best detected at a finer granularity than the given content granularity. The regional concept detection system 500 includes an image representation generation module or combiner 502, which takes the input content at a given granularity (e.g., an image 100) and produces a better suited representation (e.g., a set of regions 504) for regional concept detection purposes. Each of the regions 504 are then evaluated by the specific regional concept detectors 506 to determine a confidence score 406 with which the corresponding regional concept is present.

In some cases (e.g., for detection of regional concepts), the input content may need a different content representation (e.g., set of regions 504) than the given content representation (e.g., an image 100) to improve detection performance. This process, called a representation generation process, to improve a representation includes producing a representation at a finer content granularity than the given content granularity by module 502.

Examples of the representation generation process include but are not limited to grid-based representation generation (FIG. 2), spatial layout-based representation generation (FIG. 3), and color-based segmentation (FIG. 4). Optimizing the data representation generation process may be a difficult task and there are no known methods that optimize this process for the purposes of detection of multiple concepts. The optimal data representation for the purposes of detection of one concept may be very different from the optimal data representation for the purposes of detection of another concept. For example, while color-based segmentation may be the most appropriate representation for “Face” detection, it may be inappropriate for detection of the concept “Indoor” or “Person”. The most appropriate representation is therefore very concept-specific and the present embodiments therefore provide the tuning and generation of a concept-specific representation for the purposes of detection of multiple target concepts.

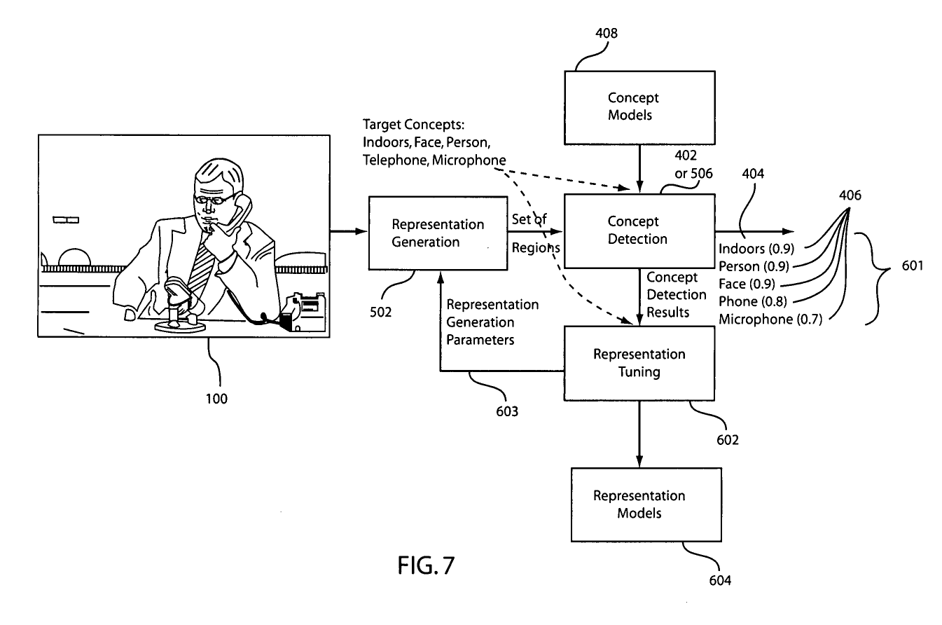

Referring to FIG. 7, a workflow of regional concept detection (FIG. 6) may be complemented by a representation-tuning module 602, responsible for adapting the representation generation process to the specific set 601 of concepts targeted for detection. The representation tuning module 602 takes as input the target concept detection (402 or 506) performance corresponding to each alternative data representation, as generated by the representation generation module 502, and adapts parameters of the representation generation module 502 to produce a suitable data representation for the target set of concepts that are to be detected. Parameters such as granularity, size of image, location in image, patterns in the image, etc. may be adjusted. The representation tuning module 602 may optionally record and/or look up the parameters of the best representation for the target set of concepts into or from a repository 604 storing the optimal concept-specific representation models, for example, historic or statistical data maintained for specific concepts.

After tuning and optimization (adjustment) of the data representation provided by feedback path 603, concept detection is applied as before using the concept detection module(s) 402 or 506 to generate concept labels 404 and corresponding detection confidence scores 406 for the input content. Note that changes in the set of target concepts may adjust the manner and method of parameter adjustments and optimization. For example, eliminating “indoors” for the target concept list would enable the tuning module 602 to focus the concept search on the person's image rather than the entire image.

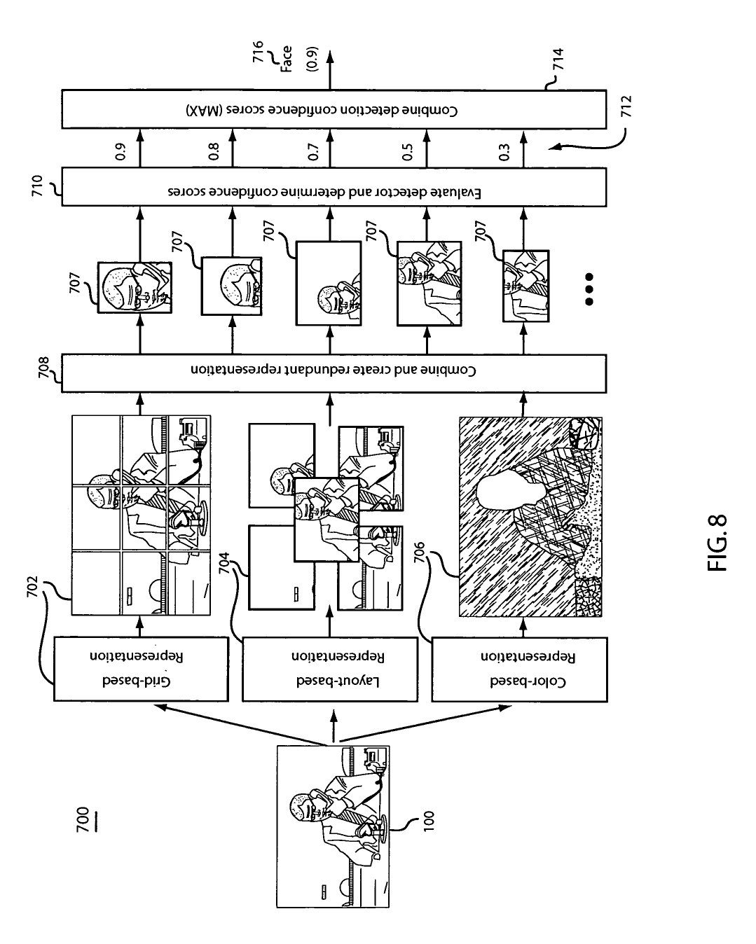

Also, note that the set of concepts is dealt with simultaneously, such that all concepts are defined and scored within the representation or representations at the same time. An example of how a preferred embodiment may work for the detection of a single concept “Face” is illustrated in FIG. 8.

Referring to FIG. 8, three different data representations are employed for system 700. These include a grid-based representation 702, a layout-based representation 704, and a color segmentation-based representation 706. The representation tuning module 602 is implemented through a combination of all three alternative representations into a single redundant representation 708. Each of the regions 707 from the combined representation 708 (including all the regions from the three alternative representations) is then evaluated, in block 710, for the presence of specific concepts, e.g., “Face” and a corresponding “Face” detection score 712 is assigned to each candidate region. The maximum regional “Face” detection score (in this case 0.9) is then assigned in block 714 to the entire input image as a confidence score 716 for detection of concept “Face”. This illustrates how “Face” detection performance can be optimized by maximizing the likelihood that if there is a face in the image, at least one of the regions from the combined redundant representation will be well aligned with that face and will therefore be a good representative of a face for the purposes of “Face” detection. The representations generated for concept detection may include combinations of generated representations as well.

Therefore, in accordance with the present disclosure, redundant content may be employed to find a single concept or a set of concepts, simultaneously. The content may be employed to find the concepts in representations by adjusting the parameters of the generation of representations to improve the likelihood of successful concept detection. Combinations or these abilities and features are also contemplated and are considered within the scope of the present invention.

Having described preferred embodiments of a system and method for generating concept-specific data representation for multi-concept detection (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims.

1. A method for detecting a concept from digital content, comprising the steps of:
generating a plurality of representations for same data content for concept detection from the plurality of representations; and
simultaneously detecting a plurality of concepts from the plurality of representations of the same data content wherein at least one detector provides selection information for selecting at least one of the representations generated or a combination of the representations.

2. The method as recited in claim 1, wherein the step of generating a plurality of representations includes generating one or more of a color-based representation, a layout-based representation, a texture-based representation and a grid-based representation.

3. The method as recited in claim 1, wherein the plurality of representations includes redundant content.

4. The method as recited in claim 1, wherein the step of generating includes selecting one or more representations from the plurality of representations.

5. The method as recited in claim 1, wherein the step of generating includes combining representations from the plurality of representations to create a representation suitable for concept detection.

6. The method as recited in claim 1, wherein the step of generating includes generating the plurality of representations independent of a process employed for generating a given representation for input content.

7. The method as recited in claim 6, wherein the step of generating includes changing the process employed for generating a given representation for input content.

8. The method as recited in claim 1, further comprising the step of determining confidence scores for each concept from the plurality of representations.

9. The method as recited in claim 1, further comprising the step of outputting a maximum confidence for a concept in one representation.

10. The method as recited in claim 1, wherein the step of detecting includes employing concept models to determine if the concept is present in a representation.

11. The method as recited in claim 1, further comprising the step of tuning a representation to provide an improved representation for concept detection.

12. The method as recited in claim 11, wherein the step of tuning includes adjusting representation generation parameters to provide the improved representation for concept detection.

13. The method as recited in claim 11, wherein the step of adjusting includes updating at least one parameter from a repository including associations between concept labels and representation creation procedures.

14. A program storage device readable by machine, tangibly embodying a program of instructions executable by the machine to perform method steps for detecting a concept from digital content, as recited in claim 1.

15. A method for detecting a concept from digital content, comprising the steps of:
providing digital content;
representing the digital content in a plurality of representations;
generating a set of regions for each of the plurality of representations for the same data content;
simultaneously detecting a plurality of concepts from the regions;
scoring each region based on confidence that the concepts exist in each region; and
processing region scores.

16. The method as recited in claim 15, wherein the step of representing includes generating one or more of a color-based representation, a layout-based representation, a texture-based representation and a grid-based representation.

17. The method as recited in claim 15, wherein the plurality of representations includes redundant content.

18. The method as recited in claim 15, wherein the step of generating includes combining representations to create a representation suitable for concept detection.

19. The method as recited in claim 15, wherein the step of generating includes generating the plurality of representations independent of a process employed for generating a given representation for input content.

20. The method as recited in claim 15, wherein the step of detecting includes employing concept models to determine if the concept is present in the representation.

21. The method as recited in claim 15, further comprising the step of tuning a representation to provide an improved representation for concept detection.

22. The method as recited in claim 21, wherein the step of tuning includes adjusting representation generation parameters to provide the improved representation for concept detection.

23. A program storage device readable by machine, tangibly embodying a program of instructions executable by the machine to perform method steps for detecting a concept from digital content, as recited in claim 15.

24. A system for detecting a concept from digital content, comprising:
a representation generation module which represents digital content in a plurality of representations by generating a set of regions for each of the plurality of representations for the same data content; and
at least one concept detector which simultaneously detects a plurality of concepts from the regions by comparing data in the region to concept models and scoring each region based on confidence that the concept exists in that region.

25. The system as recited in claim 24, further comprising a combiner, which combines representations to create a representation suitable for concept detection.

26. The system as recited in claim 24, further comprising a representation tuner to provide an improved representation for concept detection by adjusting representation generation parameters to provide the improved representation.

27. The system as recited in claim 24, wherein the parameters are included in a repository, which includes associations between concept labels and representation creation procedures.

28. The system as recited in claim 24, further comprising a score processing module, which processes the region scores generated for each concept from the plurality of representations to create an overall confidence score for each concept.
